(19) United States
(12) Patent Application Publication
(10) Pub. No.: US 2019/0031882 A1
(43) Pub. Date: Jan. 31, 2019

(54) ENHANCED FABRIC

(71) Applicant: The University of Nottingham, Nottingham (GB)

(72) Inventors: Edward Lester, Nottingham (GB); Miquel Gimeno-Fabra, Nottingham (GB)

(21) Appl. No.: 16/077,223

(22) PCT Filed: Feb. 10, 2017
(86) PCT No.: PCT/GB2017/050364

§ 371 Date: Aug. 10, 2018

(30) Foreign Application Priority Data
Feb. 12, 2016 (GB) 1602552.0

(51) Int. Cl. C09D 1/00; C03C 25/1095; C03C 25/47; D06M 23/08; D06M 11/46; D06M 11/71; C09D 7/63

(52) U.S. Cl. CPC C09D 1/00; C03C 25/1095; C03C 25/47; D06M 2101/36; D06M 11/46; D06M 11/71; C09D 7/63; D06M 23/08

(57) ABSTRACT

A method is disclosed for treating a fabric (107) to improve its mechanical properties, comprising coating the fabric (107) with a liquid suspension of particles (102), and then drying the fabric (108). A fabric (108) comprising a woven or knitted arrangement of fibres (105) is disclosed, at least some of the fibres (105) being coated with particles (102), wherein the particles (102) comprise a surface treatment (103) to make the particles (102) hydrophobic.

The present invention relates to a method for enhancing the performance of a fabric, and to an enhanced fabric. More specifically the fabric may be applied in the context of body armour.

Body armour and other protective equipment is widely used by the military and emergency services. The need to adequately protect wearers from ballistic and stab threats can make such equipment bulky and heavy—making it less desirable to wear, and causing back problems leading to issues with lost time at work.

Body armour is used in the UK by police forces, prisons and correctional institutes, councils, health authorities, fire and ambulance services and other non-governmental agencies and other non-Home Offices agencies. Nationally there are over 160,000 police and civilian staff potentially requiring some form of advanced personal protective equipment (PPE) to carry out their duties in public. Each year, typically 15,000 (rising to 30,000) sets of armour are replaced. In North America and Canada just over 1 million uniformed offices are engaged in Federal, State, Local (plus tactical), Corrections/Prisons and private security roles.

Lighter armour with acceptable performance is desirable. At present, stab vests can weigh as much as 8.5 kg, making mobility and flexibility very difficult. Also, long periods of sitting can cause discomfort (for example, in a vehicle). A further issue can arise with UV degradation and flame resistance of fabric materials that are presently used in armour. Stab resistance can be a particularly challenging test to meet, while maintaining acceptable levels of weight and flexibility.

Other applications with a need for high performance fabrics include spall liners (e.g. for armoured vehicles), fragmentation protection fabric (e.g. for helicopters, light vehicles, etc.), gabions (as flood defences or for forming temporary fortifications) and for incorporation into a composite part (that also includes a matrix material, such as a polymer). An improved fabric material for use in mechanically demanding applications is desirable.

It is known to deposit particles on fabric to try to improve the properties thereof by soaking or dipping the fabric in a liquid suspension of particles. Often, compacting methods are employed in an effort to improve impregnation and adhesion of the particles. Existing techniques lead to poorly dispersed coatings, poor adhesion of particles, and may damage fibres.

According to an aspect of the invention, there is provided a method of treating a fabric to improve its mechanical properties, comprising spray coating the fabric with a liquid suspension of particles, and then drying the fabric.

According to a first aspect of the invention, there is provided a method of treating a fabric to improve its properties, comprising coating the fabric with a liquid suspension of particles, and then drying the fabric, wherein the liquid suspension comprises an organic non-polar solvent, and the particles comprise a surface treatment to make the particles hydrophobic

The particles may be inorganic particles, or organic particles (e.g. polymeric nano-particles), or a mixture thereof.

The method may improve at least one of: the mechanical properties of the fabric, the resistance to degradation arising from exposure to light, and the flame resistance of the fabric.

The fabric may comprise a plurality of yarns that are woven or knitted to form the fabric. The yarns may comprise a plurality or bundle of fibres.

The particles of this, or any other aspect, may be nanoparticles.

The term “nanoparticle” as used herein, is in accordance with the IUPAC definition, and means that the nanoparticles have a dimension that is between 1 nm and 100 nm, or with a dimension that is between 1 nm and 500 nm. Particles with only one or two dimensions between 1 nm and 500 nm are included, for example, a plate with lateral dimensions of 2×2 μm and a thickness of 80 nm constitutes a nanoparticle within this definition. A rod shaped particle of 3 μm length, with diameter of 50 nm also qualifies as a nanoparticle.

The Sauter mean particle diameter (d₃₂) of the particles may be from 1 nm to 3 μm. Preferably, the Sauter mean diameter d₃₂ is between 1 nm and 1000 nm, or 1 nm to 500 nm, or 1 nm to 100 nm. The particles may have a median particle size (based on volume, dᵥ₅₀) of between 1 nm and 1000 nm; 1 nm to 300 nm, or 1 nm to 100 nm.

Coating the fabric may comprise depositing between 0.1% and 10% by weight of dry particles, as a fraction of the total fabric weight before treatment, or between 5% and 10%. Spray coating the fabric may comprise depositing at least 2%, 5%, 10% or 15% by weight of dry particles, as a fraction of the total fabric weight before treatment.

The method may comprise applying a further surface coating to the treated fabric.

The further surface coating may comprise polymeric material.

The further surface coating may represent less than 15%, 10%, 5%, 2%, or less than 1% of the total fabric by weight.

The fabric may comprise aramid fibres. The fabric may comprise at least one of: carbon fibres, high (or ultra-high) molecular weight polymer fibres, glass fibres, wool fibres, cotton fibres (although any natural or synthetic fibre may be used). High molecular weight polymer fibres include compositions consisting of polymer molecules with a mean molecular mass of at least 0.5 atomic mass units. The mean polymer chain length may be at least 20000 monomers. The polymer fibres may comprise polyethylene.

The liquid suspension may comprise (or substantially consist of) an organic non-polar solvent. The organic non-polar solvent may comprise Xylene, Pentane, Cyclopentane, Hexane, Cyclohexane, Benzene, Toluene, 1,4-Dioxane, Chloroform, Diethyl ether, Dichloromethane.

The term non-polar may mean having a dielectric constant less than 15, or less than 10 or 5.

The method may comprise treating the particles with a surface treatment to make the particles hydrophobic.

The surface treatment may be derived from dodecenylsuccinic anhydride, DDSA, or another carboxylic anhydride having a hydrophobic tail.

The method may comprise surface treating the particles to make them hydrophobic.

The particles may comprise at least one of: titanium dioxide, hydroxyapatite, silicon dioxide, ceria, zinc oxide, iron oxide, alumina, tungsten oxide.

The particles may originate from an aqueous synthesis process (e.g. that uses supercritical water). The method may comprise synthesising the particles with an aqueous synthesis process using supercritical water (e.g. so called hydrothermal synthesis, similar to that described in WO2005/077505). Alternatively, the particles may originate from a batch process and/or a solvothermal process.

According to a second aspect, there is provided a method of preparing a liquid for treatment of a fabric, comprising:
synthesising particles;
surface treating the particles to make the particles hydrophobic.

The method may comprise suspending the surface treated particles in the liquid.

The particles may be inorganic particles, or organic particles (e.g. polymeric nano-particles), or a mixture thereof.

Synthesising the particles may comprise using an aqueous process with supercritical water (e.g. using a hydrothermal synthesis process).

The method may further comprise extracting the hydrophobic particles into an organic non-polar solvent.

Surface treating the particles may comprise adding a surface treatment composition to an aqueous suspension of the particles. The surface treatment composition may comprise a molecule with a hydrophobic tail and at least one capped carboxyl group. The surface treatment composition may comprise DDSA.

The surface treatment composition (e.g. DDSA) may be dissolved in a solvent before being added to the suspension.

The solvent may comprise toluene, xylene, butanol, methanol, propanol, isobutyl alcohol, isopropyl alcohol, ethanol, methyl ethyl ketone, acetone or other solvents

Surface treating the particles may comprise heating the aqueous solution and surface treatment composition to at least 120° C. so as to produce carboxyl groups that bond with the particles, leaving the hydrophobic tail facing away from the particles.

The liquid suspension used according to the first aspect may be prepared in accordance with second aspect.

According to a third aspect, there is provided a method of making a garment using a fabric treated according the first aspect.

The garment may comprise personal protective equipment (e.g. safety trousers for chainsaw users, a stab-proof vest, etc.)

The fabric may comprise fibres with a diameter of between 5 and 20 microns, and the particles may have a median diameter (based on volume dᵥ₅₀) that is selected to be less than half the diameter of the fibres.

According to a fourth aspect, there is provided a liquid treating fabric to enhance the mechanical properties thereof, comprising a liquid suspension of particles, wherein the liquid suspension comprises an organic non-polar solvent, and the particles comprise a surface treatment to make them hydrophobic.

The particles may be inorganic particles, or organic particles (e.g. polymeric nano-particles), or a mixture thereof.

The particles may comprise at least one of titanium dioxide, hydroxyapatite or silicon dioxide, ceria, zinc oxide, iron oxide(s) alumina, tungsten oxide.

The organic non-polar solvent may comprise Xylene, Pentane, Cyclopentane, Hexane, Cyclohexane, Benzene, Toluene, 1,4-Dioxane, Chloroform, Diethyl ether, Dichloromethane.

The surface treatment may be derived from DDSA; or, more generally, may be derived from a composition comprising a carboxylic anhydride having a hydrophobic tail.

The particles may comprise at least 50% by volume of: platelet shaped particles; spherical particles; or rod shaped particles.

At least 50% by volume of the particles may comprise rod or plate shaped particles with an aspect ratio of at least 5.

According to fifth aspect, there is provided a fabric comprising a woven or knitted arrangement of fibres, at least some of the fibres being coated with particles, wherein the particles comprise a surface treatment to make the particles hydrophobic.

According to an aspect, there is provided a textile or fabric comprising a network of fibres, at least some of the fibres being coated with particles, wherein the particles comprise a surface treatment to make the particles hydrophobic.

The network of fibres may be formed by weaving, knitting, crocheting, knotting, or felting.

The particles may be inorganic particles, or organic particles (e.g. polymeric nano-particles), or a mixture thereof.

The loading of the particles may be between 0.1% and 10% by weight (of the untreated fabric).

The surface treatment may comprise a composition comprising at least 50% by weight of a molecule having at least one carboxylic acid group at one end, and a hydrophobic tail at the other. The molecule may be derived from DDSA.

The fabric may further comprise a polymer coating, disposed over the particles on the fabric. The loading of polymer coating may be selected to maximise the friction between fibres of the fabric.

The polymer coating may comprise shellac, at a loading of up to 0.5%.

Any of the compatible features of each aspect may be combined with those of any other aspect.

Embodiments of the invention will now be described, purely by way of example, with reference to the accompanying drawings, in which:

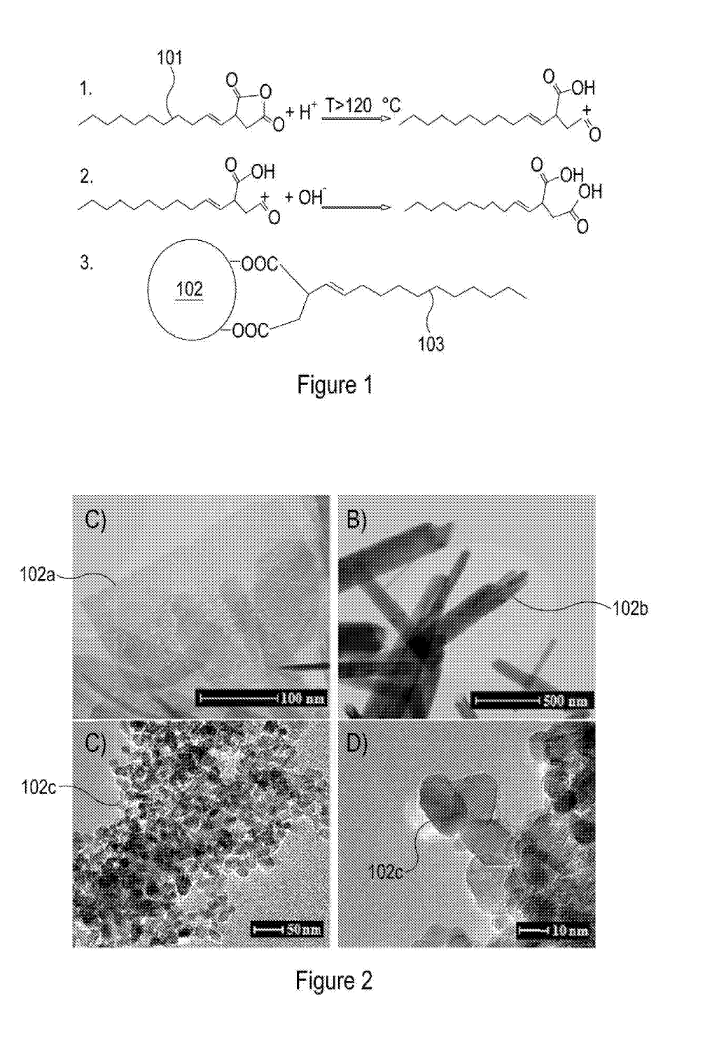

FIG. 1 shows a method for providing a hydrophobic surface coating for particles;

FIG. 2 is a set of micrographs showing: A) hydroxyapatite (HA) particles with platelet morphology; B) HA particles with rod morphology; C) and D) titania (TiO₂) particles;

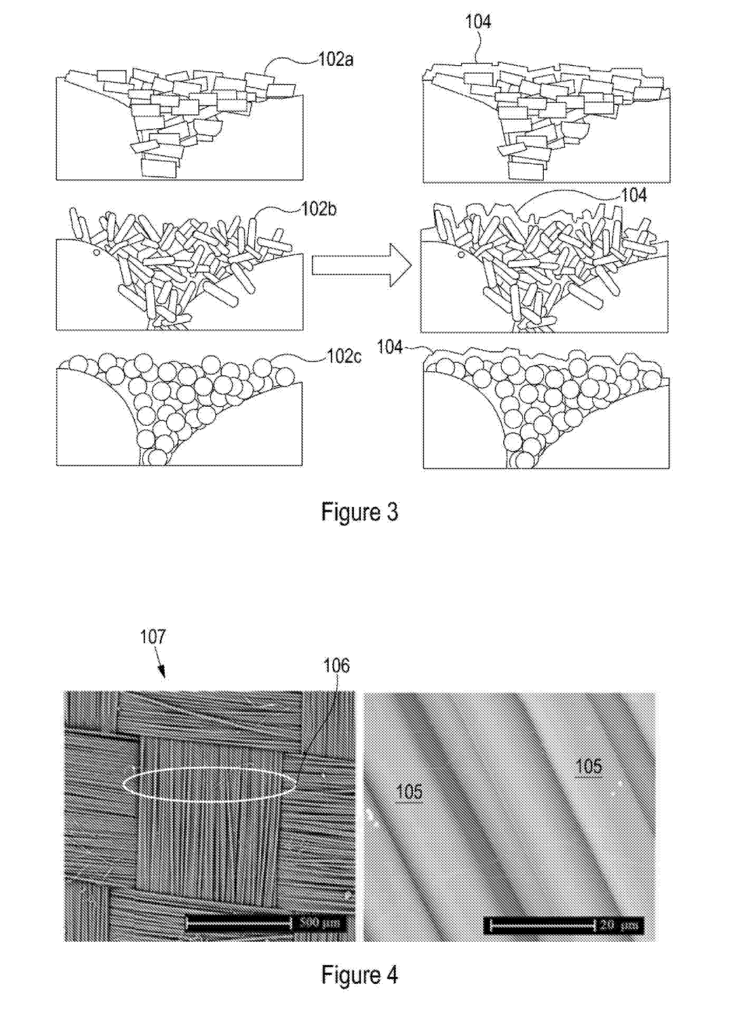

FIG. 3 shows a schematic view of particles with various morphologies at a fibre interface, with and without a polymer coating layer over the particles;

FIG. 4 is pair of micrographs of a woven fabric material comprising aramid (Kevlar®) fibres showing the woven yarns, and the individual fibres;

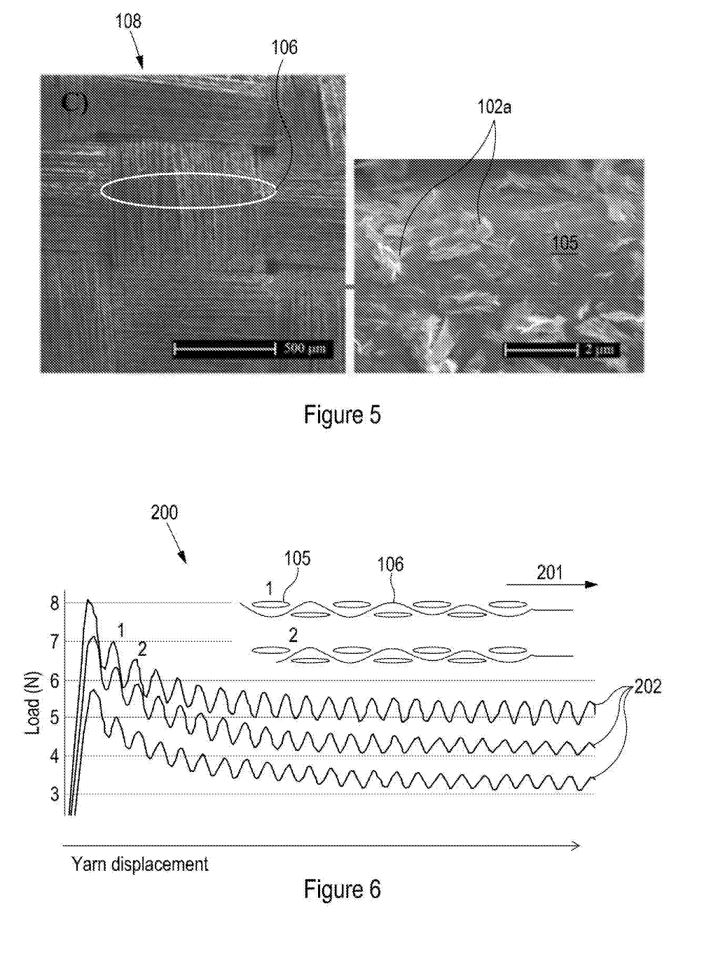

FIG. 5 is a pair of micrographs of a treated woven fabric material showing the woven yarns and a close-up of a fibre, showing HA platelets adhered to the surface of the fibres;

FIG. 6 is a graph illustrating yarn pull-out testing, and the resulting force-displacement data;

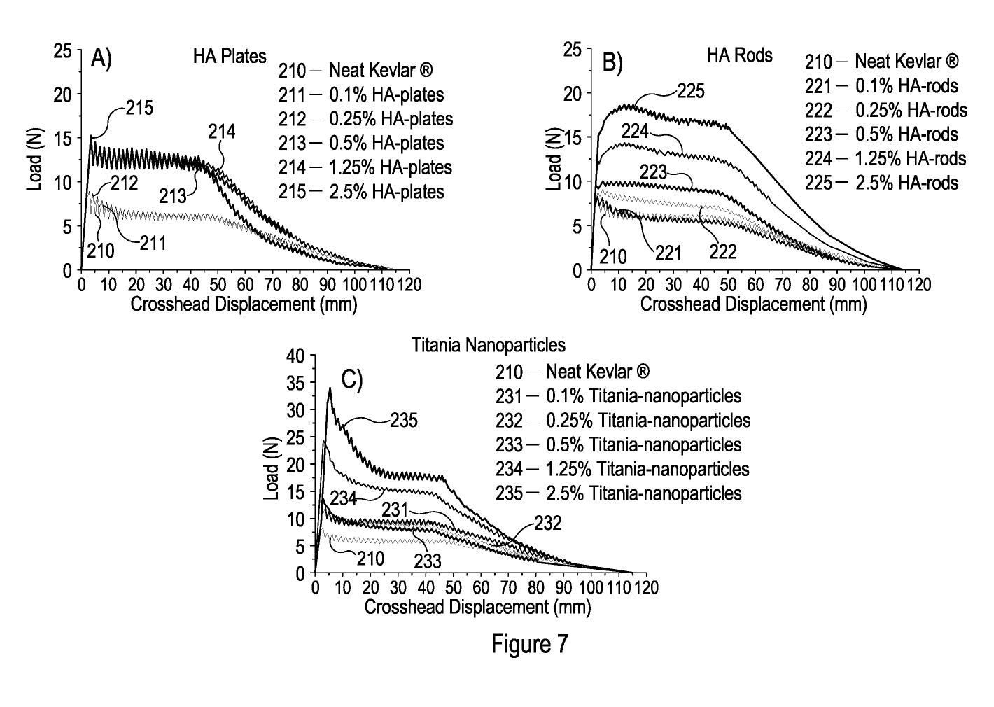

FIG. 7 is a set of graphs showing yarn pull-out force-displacement data for various loadings (by weight) for: A) HA plates; B) HA rods; and C) titania particles;

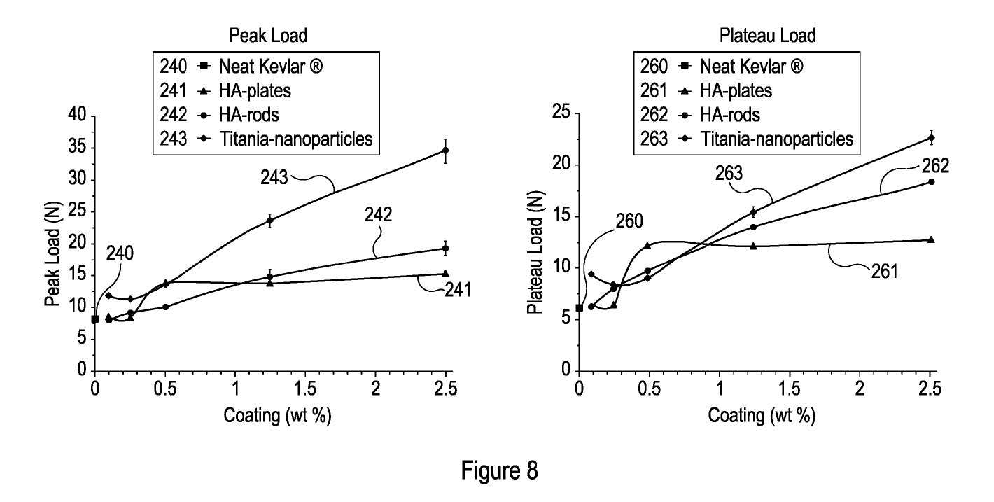

FIG. 8 is a pair of graphs showing peak and plateau yarn pull-out loads as a function of particle loading (by weight) for various types of nanoparticle;

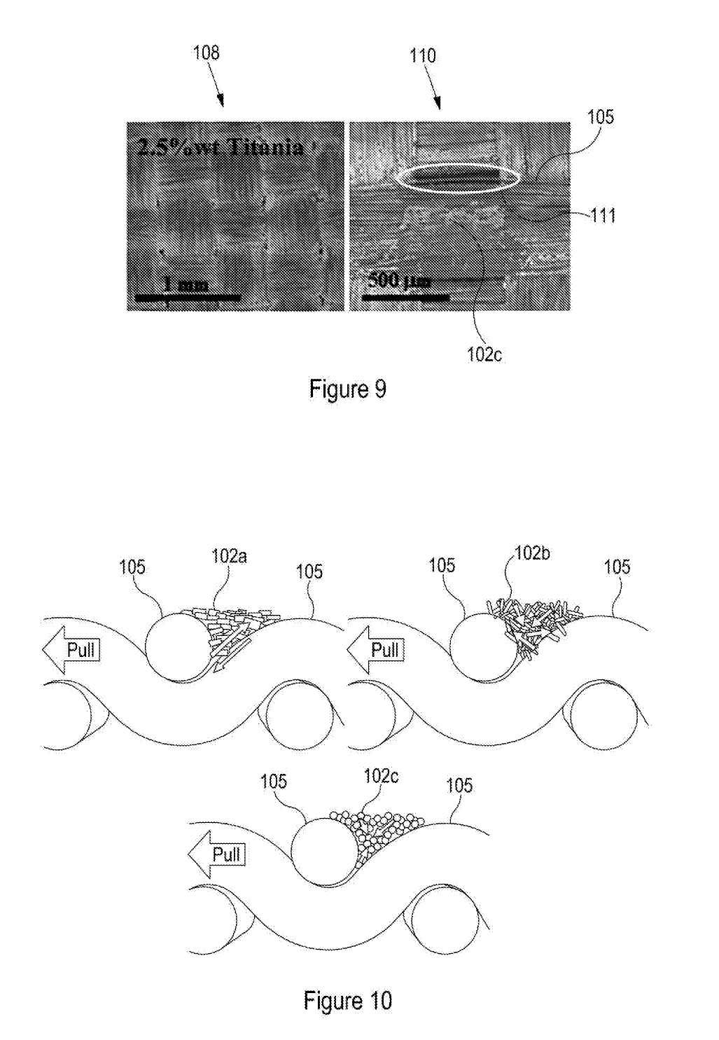

FIG. 9 is pair of micrographs showing a fabric treated with 2.5% wt. titania nanoparticles, and the same fabric after a yarn has been pulled out;

FIG. 10 is a set of schematic drawings illustrating the mechanisms by which the particles with rod, plate and sphere morphology are thought to improve the performance of the fabrics;

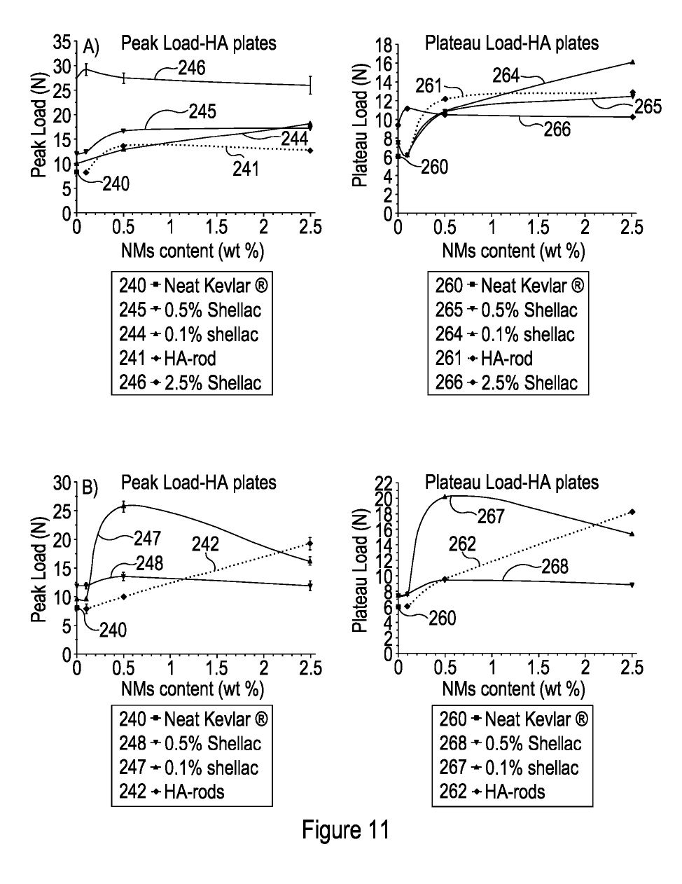

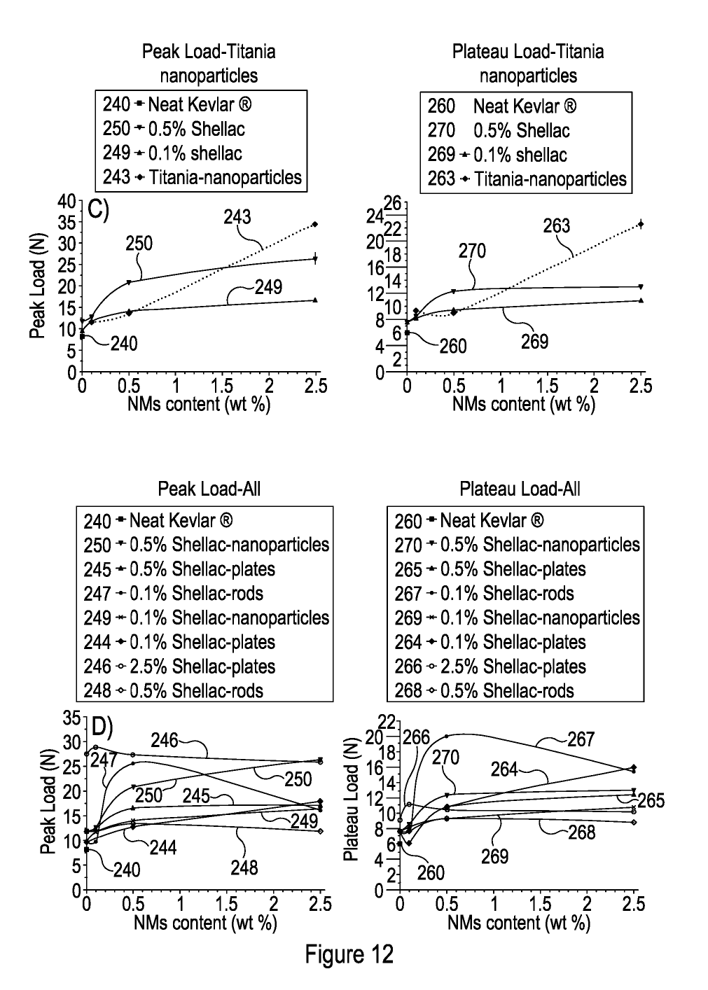

FIGS. 11 and 12 together show four pairs of graphs, for: A) HA plates; B) HA rods; C) titania particles and D) comparing HA plates and rods with titania particles, each pair of graphs showing the relationship between peak yarn pull-out load and plateau yarn pull-out load as a function of polymer coating loading (by % weight); and

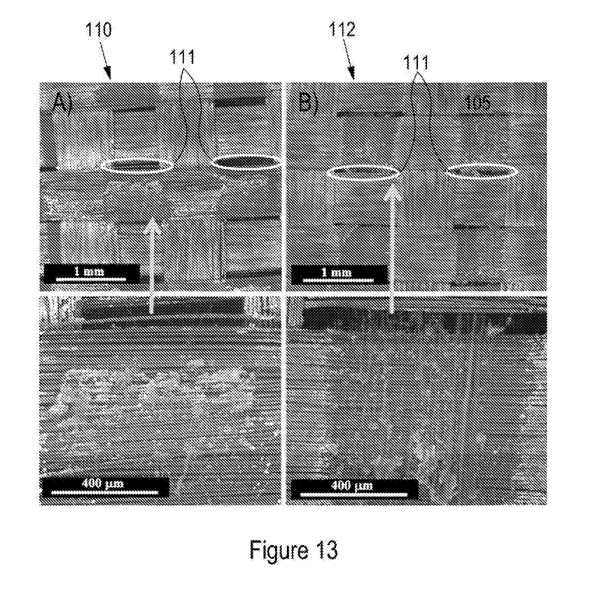

FIG. 13 is a set of micrographs showing two different magnifications of a treated fabric after yarn pull-out for: A) a fabric treated with 2.5% wt. titania only; B) a fabric treated with 2.5% wt. titania and 0.1% shellac.

Particles for treating the fabric may be sourced from any suitable process. Preferably, the particles have a well-controlled morphology and size distribution, so that the performance of the treatment be maximised for a particular fabric. One process that is suitable is hydrothermal synthesis using supercritical water, and a process of this type was used to synthesise the particles in the below embodiments.

The reactor used to synthesise the particles may be a counter-flow reactor, in which superheated water is introduced in a downward direction into an upward counter current of a second aqueous reagent (such as a metal salt). To synthesise HA, an ammonium phosphate solution may be introduced as a heated flow from the top of the reactor and a calcium nitrate solution from the bottom. This allows the modification of the pH of the ammonium phosphate solution without altering the other precursor before the reaction point, leading to instant production of single phase, stoichiometric HA. The particle morphology depends on the pH conditions used, with plates being formed with a down-flow of pH 8 and rods with a downflow of pH 10.

For synthesis of titania particles, a single precursor (e.g. a titanium salt) may be introduced from the bottom of the reactor and mixed against a down-flow of supercritical water.

In order to apply the particles to untreated aramid fibres (e.g. Kevlar®) in a way that results in the particles both being well dispersed and adhered, the particles may be surface modified to make them hydrophobic, and dispersed in a non-polar organic solvent.

In general, this can be achieved by introducing a surface treatment dissolved in a non-polar organic solvent to the flow within the reactor, before or after synthesis of the particles. The surface treatment functionalises the surface of the particles to make them hydrophobic, and the successfully treated particles are naturally extracted into the non-polar organic solvent. If the non-polar organic solvent is non-miscible with water, it is straightforward to separate it from the aqueous component of the output of the reactor, which can be discarded.

For example, the hydrophobic surface treatment may be formed by introducing dodecenylsuccinic anhydride (DDSA) following synthesis of the particles. DDSA may be delivered dissolved in toluene, mixing with the product stream after the reaction point and first cooler, but still within the pressurised system.

As shown in FIG. 1, DDSA comprises a carboxylate ligand and a hydrophobic tail 103 which can be used to provide a hydrophobic surface treatment for the particles 102. DDSA acts as a protected di-carboxylic acid, where the carboxyl functional groups are protected until the ring structure is opened. The ring will open at temperatures exceeding 120° C., as shown in step 1 of FIG. 1. The addition of an —OH group (in step 2) produces an di-carboxylic acid, which interacts with hydroxyl groups on the surface of the particles 102. This interaction may be electrostatic interaction and covalent bonding (especially for HA, which has a high content of —OH groups) or through hydrogen bonding (for titania). Step 3 in FIG. 1 shows the modified DDSA molecule binding to a titania particle 102 in this way.

Examples of suitable particles produced by the above process are shown in FIG. 2, which shows: HA plates 102a, which are polydisperse having dimensions of about 400×150 nm up to around 2×2 μm, with thickness less than 80 nm; HA rods 102b with a diameter of 30-40 nm and variable length, and titania particles 102 with a particle size of 10-15 nm. An amorphous material is visible around the crystalline particles 102a-c, forming a layer of around 1 nm, which is attributable to the surface coating derived from DDSA on their surfaces. The morphologies of both the HA particles 102a, 102b is consistent with hexagonal, stoichiometric hydroxyapatite. For the titania particles 102c, crystallographic data was consistent with anatase TiO₂, which is a tetragonal structure of stoichiometric TiO₂.

The hydrophobic particles (with DDSA derived hydrophobic surface treatment) will naturally extract from the water in which they were synthesised into the non-polar toluene. Since toluene is immiscible with water, the final product naturally separates into two layers, with the organic phase containing the successfully hydrophobically functionalised particles.

After washing and drying, thermal analysis of particles showed DDSA contents of about 40.7, 24.2 and 12.3% wt. for HA plates, HA rods and titania nanoparticles respectively. Although the TiO₂ nanoparticles have an increased specific surface area (200 m²g⁻¹ compared with around 20 m²g⁻¹ and 30 m²g⁻¹ for the HA plates and rods previously described), the HA particles showed higher loadings, which may be due to a greater tendency for covalent bonding with —OH on the surface of HA.

The fabric may comprise aramid fibres such as Kevlar®, or may comprise graphite/carbon fibres, high (or ultra-high) molecular weight polymer (such as polyethylene) fibres, or glass fibres. In the example embodiment, the untreated fabric comprised clean Kevlar® fibres arranged in bundles to form yarns, the yarns being woven to define the fabric. In other embodiments the fabric may be knitted.

FIG. 4 shows a micrograph of the untreated fabric 107, in which the yarns 106 and fibres 105 are clearly visible. The fibres are around 10 μm in diameter, and the weaving pitch around 1.4 mm. In other embodiments the fibres 105 may be as small as 2 μm, or as large as 1 mm in diameter.

In order to avoid the problems of with prior art dipping processes, a spray coating process may be used to add the particles to the fabric 107. Preferably, the hydrophobic functionalised particles are incorporated into an organic non-polar solvent (such as, Pentane, Cyclopentane, Hexane, Cyclohexane, Benzene, Toluene, 1,4-Dioxane, Chloroform, Diethyl ether, Dichloromethane), and then applied onto the fabric 107 (e.g. by spraying). The solvent is subsequently evaporated (e.g. in a drying process), leaving behind the particles. Non-polar solvents tend to wet the fibres of the fabric more readily, which results in a more uniform distribution of particles. The particles were found to adhere well to the aramid fabric used in the example embodiments, and it is expected that this will also apply for other types of fibre (e.g. carbon/graphite, glass, etc). The solvent in which the particles are suspended for spraying is preferably substantially non-toxic, so as to minimise the potential for any harmful residues.

In some embodiments, a polymer coating 104 may be applied to the fabric 108 after the particles 102 have been added. FIG. 3 illustrates the process, with a conformal polymer layer 104 being shown deposited over particles with plate 102a, rod 102b and spherical morphology 102c respectively. The coating may enhance the properties of the fabric 108, for instance by enhancing the binding of the particles 102 with the surface of the fabric 108. Any suitable polymer may be used, such as shellac, parylene, ethylene/methyl acrylates etc.

In the example embodiments described below, shellac was used as a polymer coating, at loadings of up to 2.5% wt. with respect to the untreated fabric 107. The polymer coating process used preferably should be undertaken at room temperature, avoiding physical or chemical alteration of the fibres 105, with minimal diffusion of the polymer into the fabric.

FIG. 5 shows an example fabric 108 after spray treatment with a solvent HA particles 102a with plate morphology. A first view of the woven yarns 106 is shown, and a second, close-up, view of a fibre 105 is shown, in which individual particles 102a can be seen. The view shown in FIG. 5 can be contrasted with the smooth clean surfaces shown in FIG. 4. An obvious increase in the particles 102 can be seen with increasing coating loading for 0.1% wt. to 2.5% wt, the yarns 106 appearing to be substantially fully coated at 2.5% wt. increase after drying.

HA plates 102a were found to have a tendency to align on the surface, and form a crust-like coating. In contrast, HA rods 102b aligned substantially randomly across the surface of the yarns, while still being evenly distributed. Transmission electron microscopy (TEM) analysis of the particles showed that the titania particles were too small to be seen using a scanning electron microscope (SEM), at generally less than 20 nm in diameter. Samples that also included a polymer 104 did not show any visual difference with the polymer-free samples, which may indicate some degree of diffusion of the polymer into the layer of particles 102, or that the polymer coating was very thin and evenly distributed.

For the HA plates 102a, HA rods 102b and titania spheres 102c, an increase in material content led to two distinct types of coating: The ones with 0.1-0.5% wt increases, which seemed to be embedded onto the fibres' surface, somewhat like micro- or nano-texturing; and the samples with 2.5% loads (or higher), showing full coverage of the textile. All the samples that have been analysed using SEM were previously subject to cutting, bending and transport, and no cracks or peeling of the coatings was observed, indicating that the particles are well adhered.

One way to investigate the effect of the coatings on fabric performance is with a yarn pull-out test. Yarn pull-out is an important energy dissipation mechanism within fabrics where the yarns (e.g. tows) of bundled fibres are pulled through the yarn cross over points. For woven fabrics, the yarn pull-out is influenced by the yarn-to-yarn frictional properties. Increasing the inter-yarn friction (both static and dynamic) without premature yarn tensile failure is a feasible way to increase the total pull-out energy, enhancing the penetration and ballistic properties of a fabric.

FIG. 6 illustrates some example data from a yarn pull-out test, which takes the form of load vs displacement of the loaded end of yarn. During a first stage, the loaded yarn straightens, and locally disrupts the woven architecture of the fabric. This stage is substantially linear. When the yarn is fully straightened, a peak load is reached corresponding with the static friction on the straightened yarn. Any subsequent movement requires that the yarn slides through the cross over points. As each crossover point is crossed by the trailing end of the yarn, the force oscillates.

FIG. 7 shows pull-out data for fabric samples 108 treated with particles 102 (with no additional polymer layer 104). Although the interactions between the DDSA coated materials and the Kevlar® fibres 105 used in these tests are thought to be weak (due to hydrogen bonding or Van der Waals interactions), the coatings did not peel off during handling or testing, indicating good binding or physical entrainment of the coatings. Tests were performed for loadings of 0.1%, 0.25%, 0.5%, 1.25% and 2.5% for each of the HA plates 102a, HA rods 102b and titania particles 102c shown in FIG. 2, and the results 211-235 are plotted with results from an uncoated fabric sample 210, for reference.

FIG. 8 summarises the data shown in FIG. 7, showing the relationship between peak pull-out load and particle loading, and the relationship between plateau pull-out load and particle loading. The peak load for uncoated Kelvar® is shown as point 240, and the peak loads for HA plates 241, HA rods 242 and titania particles 243 are shown on one graph. On the other graph, the plateau load for uncoated Kelvar® fabric is shown as point 260, with the plateau loads for HA plates 261, HA rods 262 and titania particles 263.

For the HA plates 102a, at the lowest loading (0.1% wt.) the particles 102a have little effect. The main increase in peak and plateau loads occurred for weight additions of 0.5% wt, wherein the peak load increased over 60% and the plateau load by over 90% (compared to 0.1% loading). The further increase to 2.5% loading only increased peak load by 19% and plateau load by 10% (compared to 0.5% loading). The less abrupt effect over frictional forces with loadings over 0.5% wt. are thought to be due to the tendency of the plates 102a to stack together flat on top of each other. This may mean that friction offered by the plates 102a results from the initial surface layer (in contact with the fibre 105), and is not improved by increased thickness of coating, as illustrated in FIG. 10.

For the HA rod 102b treatment frictional improvements were almost linear with increasing particle load. A 0.5% loading of HA rods 102b resulted in a 23% increase in peak force (compared with uncoated Kelvar® 210), and a 2.5% loading an increase of 134%. The enhanced yarn pull-out performance with rod particle morphology may be due to the random orientation of the rods at a microscopic level. As schematically illustrated in FIG. 10, this may increase the contact points between the particles 102b and the fibres 105 of the fabric (of both the yarn being pulled, and of the crossover yarn). The lack of a large difference between peak and plateau load for HA rod treated samples further indicates that the increase in friction co-efficient (from μ=0.011 to 0.017) came from the random interactions that occurred between the rods once the yarns were in motion. SEM images after yarn pull-out showed little evidence of fibre failure at any of the studied coating concentrations.

The data (231-235, 243 and 263) for samples treated with titania particles shows a different character than the HA plates or HA rods. Even at the lowest weight increase of 0.1% wt there was a significant increase in peak and plateau loads, or 41% and 54% respectively (compared with uncoated Kelvar®). This is due to the higher specific area of the titania particles, which provide more surface area to interact with the yarns 106 and fibres 105. A subsequent increase to 0.5% wt. loading did not show significant improvement in frictional forces, which could be due to frictional slippage between the particles of the coating. The overall friction in the 0.25% and 0.5% samples may come from the available surface of the TiO₂ itself, which was similar independently of the coating content, but showed a shear thinning-like effect within the coating. Similar shear thinning behaviours have previously been observed for concentrated suspensions of spherical particles. At 1.25% and 2.5% wt titania, the yarn pull-out peak and plateau loads showed an abrupt increase (at 318% and 273% higher than uncoated Kevlar® for the 2.5% wt. loading). This increase could have been because of shear thickening-like properties within the coating, where the TiO₂ coatings comprising high specific surface area nano-particles thickened when stressed, as the individual particles clustered together, impeding the free movement of the translating yarn. This mechanism is schematically illustrated in FIG. 10.

FIG. 9 illustrates a treated fabric 108 before and after pull-out testing. After pull-out testing a void 111 is visible where the pulled-out yarn 106 used to be. Pile-up of particles 102c can be seen adjacent to the edge of the void 111, further supporting the clustering friction enhancement mechanism. For the 2.5% wt. titania sample data 235, the drop in force observed between the peak and the plateau loads (from ca. 34 N to 22 N) came from fibre fraying during the pull and/or loss of some coating agent, as during testing it was observed that the high pull-out forces made the sample vibrate. SEM images of the 2.5% TiO₂ sample after pull-out showed that fibres from the pulled yarn were left at the crossover points.

FIG. 11 shows peak and plateau pull-out load data as a function of particle loading for HA plates and HA rods, with varying amounts of polymer coating.

For HA plates A), peak data for: no shellac 241, 0.1% shellac 244, 0.5% shellac 245 and 2.5% shellac 246 are shown, with uncoated Kevlar® 240 as a reference point. HA plate plateau data are also shown for: no shellac 261, 0.1% shellac 264, 0.5% shellac 265 and 2.5% shellac 266, with uncoated Kevlar® 260 as a reference point.

As expected from the low content of plates, the increase in peak and plateau loads in all the polymer-composite samples with 0.1% wt and 0.5% wt plates came only from the shellac coating. When the content of plates was increased to 2.5% wt, the heavier polymer coatings (0.5% and 2.5% wt shellac) shielded any effects from the hydroxyapatite. In contrast, 2.5% wt plates with 0.1% shellac showed higher pull-out forces, up to 118% and 164% greater than uncoated Kevlar®, and ca. 100% and 140% more than the 0.1% shellac-only coated sample for peak and plateau loads respectively. It was unclear whether the polymer had soaked into the plates, as the SEM images of these samples did not show any obvious difference with the shellac-free analogous. Coatings with 2.5% shellac were used with this morphology to show that high polymer loadings tend to stop the nanoparticles underneath having any effect on yarn pull-out forces (the results are similar to what would be obtained with shellac alone).

For HA rods B), peak data for: no shellac 242, 0.1% shellac 247, and 0.5% shellac 248 are shown, with uncoated Kevlar® 240 as a reference point. HA rod plateau data are also shown for: no shellac 262, 0.1% shellac 267 and 0.5% shellac 268, with uncoated Kevlar® 260 as a reference point.

Composite samples of rods (1st coating) with a top layer of 0.5% wt shellac showed no obvious improvement when compared to the nanomaterial-free analogues. An advantage of the rods (with no shellac), was that they increased the yarn-to-yarn friction through random interactions between them when in motion/stressed. At this shellac content (0.5% wt), the rods were prevented from moving when the yarn was being pulled, which decreased the overall forces within the sample at all particle loadings. In contrast, when shellac was added as a 0.1% wt top layer, the frictional effect of the rods was maximised at rod contents of 0.5% wt, but not at 2.5% weight. The 0.5% wt rods with 0.1% wt shellac, proved to be an almost ideal combination where the shellac content increased the effect of the rods rather than annulling it. The 1:5 shellac:HA-rods ratio may have modified the way the rods interacted with each other and with the yarn being pulled. The polymer content may be high enough for the rods to be immobilised, but sufficient to increase the friction between them, the overall viscosity within the coating or the binding with the Kevlar®. In addition, both peak and plateau loads were maximised, giving performances 212% and 231% higher than uncoated Kevlar®. For top layers of 0.1% wt shellac, when the content of rods was increased from 0.5 to 2.5% wt, the performance was compromised because of the excess of rods for the amount of shellac used. This minimised any effect from the polymer layer, as shown in FIG. 11 B). Given the high increase in yarn pull-out forces measured for the 0.5% wt HA rods-0.1% wt shellac sample, triplicates were analysed, always giving the same yarn-pull out results. Furthermore, this sample had a total weight increase of 0.6% wt. which is a very low loading for such a marked improvement. A reduced loading results in a lower cost of treatment.

For samples coated with titania nanoparticles (with substantially spherical morphology), further addition of shellac had little beneficial effects on the overall yarn pull-out performance of the fabrics, as shown in FIG. 13 C). Coatings made of TiO₂-DDSA are thought to increase yarn-to-yarn friction due to shear thickening-like effects. The individual particles are thought to cluster together when stressed, partially impeding the free movement of the yarns. In contrast, although at their lowest weight addition there was an increase in the peak and plateau loads by around 41% and 53% respectively, at 0.5% wt the peak load increased only by a further 20%, and the plateau load decreased over 5%. This suggested shear thinning-like behaviour. In any case, the mechanism followed by the titania nanoparticles to act as frictional agent seemed to rely on their large surface area and small size (ca. 200 m²g⁻¹ and <20 nm) as well as the ability of the particles to have some degree of movement. As an example, when a top layer of 0.5% wt shellac was added to the 2.5% wt titania sample, the composite fabric showed a decrease of almost 50% in plateau load and 40% in peak load respect to the 2.5% wt titania coated Kevlar® (without the polymer). The only titania-shellac coated sample that performed significantly better (>50%) than either its shellac or titania-only analogues was the 0.5% wt. titania—0.5% wt. shellac, showing a 153% higher peak load than uncoated Kelvar®, more than twice that of 0.5% TiO₂-DDSA only, and about three times better than 0.5% shellac.

FIG. 13 shows a comparison of SEM images obtained after yarn pull-out for 2.5% wt. titania coated fabric 108, without a polymer layer A) and with a 0.1% wt. shellac layer B). The same level of yarn fraying and broken fibres was observed with and without the shellac coating.

The pull-out data showed that coatings according to embodiments are very promising, offering large increases in performance at relatively low particle loadings. Dramatic improvements in stab resistance are to be expected from fabrics treated according to embodiments. Embodiments of the present invention are also expected to improve UV degradation properties and flame resistance of fabric materials.

A number of modifications and variations will be apparent to the skilled person, and the above embodiments are not intended to limit the scope of the invention, which is determined only by the appended claims.

1-40. (canceled)

41. A method of treating a fabric to improve its properties, comprising coating the fabric with a liquid suspension of particles, and then drying the fabric, wherein the liquid suspension comprises an organic non-polar solvent, and the particles comprise a surface treatment to make the particles hydrophobic.

42. The method of claim 41, wherein coating the fabric comprises one of:
(i) spray coating the fabric with the liquid suspension; and
(ii) depositing between 0.1% and 10% by weight of the dry particles, as a fraction of the total fabric weight after treatment.

43. The method of any of claim 42, comprising applying a further surface coating to the treated fabric.

44. The method of claim 43, wherein the further surface coating comprises polymeric material and represents less than 5% of the total fabric by weight.

45. The method of claim 41, wherein the fabric comprises at least one of: aramid fibres, carbon fibres, ultra-high molecular weight polymer fibres, glass fibres, wool fibres, cotton fibres.

46. The method of claim 41, wherein the organic non-polar solvent comprises Xylene, Pentane, Cyclopentane, Hexane, Cyclohexane, Benzene, Toluene, 1,4-Dioxane, Chloroform, Diethyl ether, Dichloromethane.

47. The method of claim 41, wherein the surface treatment is derived from dodecenylsuccinic anhydride, DDSA.

48. The method of claim 41, comprising surface treating the particles to make them hydrophobic.

49. The method of claim 41, wherein the particles comprise at least one of: titanium dioxide, hydroxyapatite, silicon dioxide, ceria, zinc oxide, iron oxide, alumina, and tungsten oxide.

50. The method of claim 49, wherein the particles originate from an aqueous synthesis process comprising synthesising the particles with an aqueous synthesis process.

51. A method of preparing a liquid for treatment of a fabric, comprising:
synthesising particles; and
surface treating the particles to make the particles hydrophobic.

52. The method of claim 51, wherein synthesising the particles comprises synthesising the particle with an aqueous process using supercritical water.

53. The method of claim 52, further comprising extracting the hydrophobic particles into an organic non-polar solvent.

54. The method of claim 53, wherein surface treating the particles comprises adding a surface treatment composition comprising a carboxylic anhydride having a hydrophobic tail to an aqueous suspension of the particles.

55. The method of claim 54, wherein the surface treatment composition is dissolved in a solvent before being added to the suspension and wherein the solvent comprises toluene.

56. The method of claim 52, wherein surface treating the particles comprises heating the aqueous suspension to at least 120° C. so produce carboxyl groups that bond with the particles.

57. The method of claim 41, further comprising making a garment using the treated fabric and wherein the garment comprises personal protective equipment.

58. The method of claim 51, wherein the fabric comprises fibres with a diameter of between 5 and 20 microns, and the particles have a median diameter that is selected to be less than half the diameter of the fibres.

59. A liquid for spray treating fabric to enhance the mechanical properties thereof, comprising a liquid suspension of particles, wherein the liquid suspension comprises an organic non-polar solvent, and the particles comprise a surface treatment to make them hydrophobic and wherein the particles comprise at least one of titanium dioxide, hydroxyapatite, silicon dioxide, ceria, zinc oxide, iron oxide(s) alumina, and tungsten oxide, and wherein the organic non-polar solvent comprises Xylene, Pentane, Cyclopentane, Hexane, Cyclohexane, Benzene, Toluene, 1,4-Dioxane, Chloroform, Diethyl ether, Dichloromethane.

60. The liquid of claim 59, wherein the particles comprise at least 50% by volume of: platelet shaped particles; spherical particles; or rod shaped particles.

61. The liquid of claim 60, wherein at least 50% by volume of the particles comprise rod or plate shaped particles with an aspect ratio of at least 5.

62. A fabric comprising a woven or knitted arrangement of fibres, at least some of the fibres being coated with particles, wherein the particles comprise a surface treatment to make the particles hydrophobic and comprising a loading of particles of between 0.1% and 10% by weight, and wherein the particles comprise titania and/or hydroxyapetite, and wherein the surface treatment comprises a polymer coating, disposed over the particles on the fabric.

63. The fabric of claim 62, wherein the surface treatment comprises at least 50% by weight of a molecule having at least one carboxylic acid group at one end, and a hydrophobic tail at the other, and wherein the molecule is derived from DDSA.
